(19) United States
(12) Patent Application Publication
(10) Pub. No.: US 2009/0153466 A1
(43) Pub. Date: Jun. 18, 2009

(54) Method and System for Optimizing Scrolling and Selection Activity

(76) Inventor: Patrick Tilley, Coram, NY (US)

Correspondence Address: Fay Kaplun & Marcin, LLP/ Motorola, 150 Broadway Suite 702, New York, NY, 10038, US

(21) Appl. No.: 11/956,976

(22) Filed: Dec. 14, 2007

(51) Int. Cl. G09G 5/00; G08B 21/00

(52) U.S. Cl. 345/156; 340/540

(57) ABSTRACT

Described are a method, a device, and a system for activating and deactivating a scrolling operation. The method includes receiving an input signal from an input interface on a mobile unit (“MU”), activating a scrolling operation of a display of the MU, sensing at least one of a motion and an orientation of the MU, and scrolling the display of the MU based on the one of the sensed motion and the sensed orientation of the MU. The device includes a display, an input interface for receiving an input signal, at least one sensor for sensing at least one of an orientation and a motion of the mobile computing device, and a processor receiving the input signal from the input interface, activating a scrolling operation of the display and scrolling the display of the device based on the one of the sensed motion and the sensed orientation of the device.

### FIELD OF INVENTION

The present invention is related to systems and methods used for activating and deactivating a scrolling operation.

### BACKGROUND

Business enterprises as well as individuals rely on mobile computing devices, or mobile units (“MUs”), in a variety of situations ranging from basic everyday tasks, such as telecommunications, to highly specialized procedures, such as inventory gathering. As the benefits of utilizing MUs continue to be realized across increasingly diverse industries, the features and capabilities of these products are expanding at a correspondingly rapid pace. In many industries, MUs have gone from fashionable accessories to essential business components used by all levels of personnel.

Accordingly, a demand has developed for MUs to perform complicated tasks quickly, efficiently and reliably. However, as conventional MUs are fitted with more advanced components and software features, sacrifices are often made with respect to power management and user-friendliness. While many methods have been devised attempting to resolve these difficulties, MUs currently continue to suffer from problems of inefficient power usage, complicated operational procedures and on-screen menus, and requiring manual input.

### SUMMARY OF THE INVENTION

The present invention relates to a method, a device, and a system for activating and deactivating a scrolling operation. The method includes receiving an input signal from an input interface on a mobile unit (“MU”), activating a scrolling operation of a display of the MU, sensing at least one of a motion and an orientation of the MU, and scrolling the display of the MU based on the one of the sensed motion and the sensed orientation of the MU. The device includes a display, an input interface for receiving an input signal, at least one sensor for sensing at least one of an orientation and a motion of the mobile computing device, and a processor receiving the input signal from the input interface, activating a scrolling operation of the display and scrolling the display of the device based on the one of the sensed motion and the sensed orientation of the device. The system includes a receiving means receiving an input signal from an input interface on a MU, an activating means activating a scrolling operation of a display of the MU, a sensing means sensing at least one of a motion and an orientation of the MU, and a scrolling means scrolling the display of the MU based on the one of the sensed motion and the sensed orientation of the MU.

### BRIEF DESCRIPTION OF THE DRAWINGS

FIG. 1 shows an exemplary MU according to the exemplary embodiments of the present invention.

FIG. 2 shows an exemplary method for controlling the functions of a scrolling operation on a display of the MU according to an exemplary embodiment of the present invention.

FIG. 3 shows the two exemplary motions and orientations in which the MU may adopt in an exemplary three-dimensional space according to the exemplary embodiments of the present invention.

### DETAILED DESCRIPTION

The present invention may be further understood with reference to the following description of exemplary embodiments and the related appended drawings, wherein like elements are provided with the same reference numerals. The present invention is related to systems and methods used for using spatial orientation and/or motion data from a mobile unit (“MU”) to manage the operation of the MU. Specifically, the exemplary embodiments of the present invention are related to systems and methods for controlling the initiation and the termination of a scrolling function of an MU, such as a handheld computing device, a cellular telephone, etc.

Accordingly, the exemplary embodiments of the present invention allow for selectively activating and deactivating motion/orientation sensors within the MU for improved accuracy and response time for the selection of a graphical representation (e.g., an icon) on a display of the MU (e.g., a graphical user interface (“GUI”)). By allowing a user to control when the motions and orientation of the MU are monitored, the user may prevent any undesired scrolling and/or selection of a menu item, an icon, a tab, a line of text, or any other area within the display of the MU. Thus, the exemplary systems and methods described herein allow for simplified browsing and selecting of items displayed on the MU by a user. For example, these exemplary systems and methods may improve one-handed operation of such MUs.

Those skilled in the art would understand that the term “MU” according to the present invention may also be used to describe any mobile computing device, such as, for example, mobile telephones, personal digital assistants (“PDAs”), portable barcode scanners (i.e., laser and/or imager-based scanners), radio frequency identification (“RFID”) readers, voice over Internet protocol (“VoIP”) telephone receivers, two-way pagers, digital cameras, portable media players, laptop computers, portable gaming consoles, etc. Regardless of which type of computing device is implemented with the exemplary methods and systems of the present invention, the MU may include an interactive GUI for displaying browsable items for selection by the user.

According to exemplary embodiments of the present invention, the MU may include spatial sensors measuring the motions of the MU, such as acceleration, velocity, and angular velocity in any direction, in addition to the orientation of the MU with respect to the user. Specifically, the measurements of the motions and orientations of the MU may be monitored by piezoelectric sensors, optical switches, accelerometers, strain/pressure gages, gyroscopes and other applications utilizing micro-electromechanical systems (“MEMS”) technologies, or any combinations of the like. As will be described below, predetermined procedures may then be executed that may be useful in a wide range of applications, including but not limited to power management, display orientation, gesture input, compensating for undesired motion, security, etc. Those skilled in the art would further understand that various additional functionalities may be added to the MU through hardware and software modules.

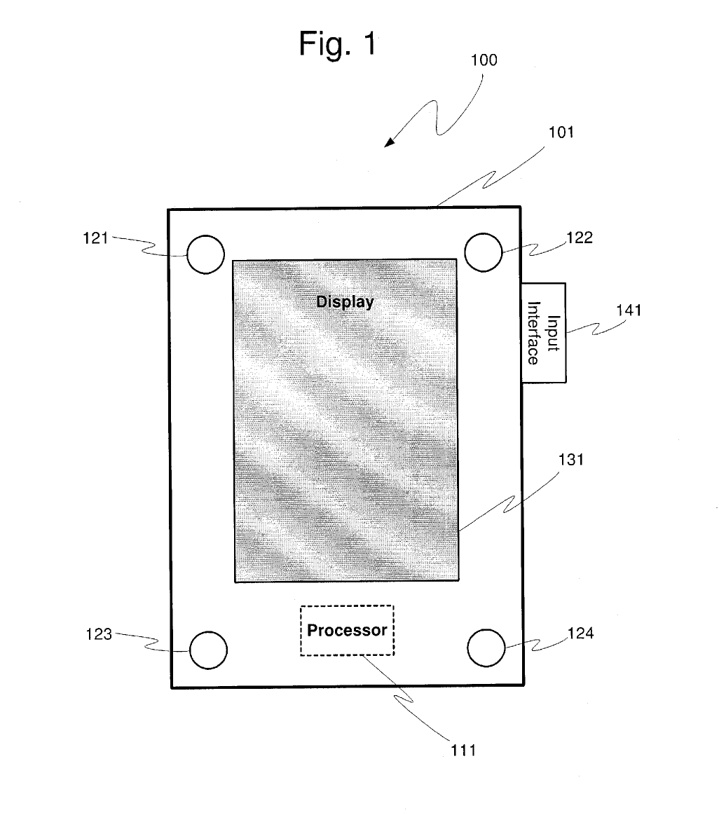

FIG. 1 shows an exemplary MU 101 according to the exemplary embodiments of the present invention. Exemplary embodiments of the MU 101 may include a multi-purpose handheld computer, a cellular telephone, a PDA running a third-party operating system, such as, for example, Microsoft Windows CE, or similar devices. Alternatively, the MU 101 may be an embedded system running a customer-specific real-time operating system (“RTOS”). The MU 101 may include a processor 111, one or more spatial sensors 121-124, a display 131, and an input interface 141. The processor 111 may be a central processing unit (“CPU”) that executes instructions and manages modes of operation based on measurements taken by the sensors 121-124.

The exemplary input interface 141 of the MU 101 may allow for users of the MU 101 control the initiation and termination of a scrolling operation on the display 131. Those skilled in the art would understand that a scrolling operation may be used to describe the act of sliding, or otherwise adjusting, a horizontal or vertical presentation of content, such as text, icons, images, etc., across the display 131 of the MU 101. For example, the scrolling operation may be used to show large amounts of data that would otherwise not fit on the display 131 all at the same time. Accordingly, when the user wants to scroll the data on the display 131, the user may activate the input interface 141 and then control the direction of the scrolling operation by adjusting the orientation and/or motion of the MU 101. In addition, the user may deactivate the scrolling operation via the input interface 141 or, alternatively, via a further input method. As will be described in greater detail below, examples of the input interface 141 may include, but are not limited to a depressible button on the surface of the MU 101, a keypad, a trigger, a touch screen, a microphone for voice commands, etc. Furthermore, as opposed to being located directly on the MU 101, alternative embodiments of MU 101 may have the input interface 141 incorporated into a remote device such as a headset, ring scanner, a wrist computer, a wrist watch, etc.

According to the exemplary embodiments of the present invention, the sensors 121-124 may be integrated into the MU 101. Furthermore, the sensors 121-124 may be used to monitor any detectable activity by the user or by the MU 101, regardless of whether the activity is monitored via a hardware component of the MU 101, a software component of the MU 101, or any combination thereof. It should be noted that while the exemplary MU 101 is illustrated with four sensors 121-124, any number of sensors may be placed within or on the MU 101.

The sensors 121-124 may be coupled to an electronic architecture of the MU 101 that dispatches data to a separate memory device, or it may be coupled to at least a portion of another device in the architecture. For instance, in the latter embodiment, the sensors 121-124 may be coupled to a memory arrangement in which event data (e.g., data relating to the orientation and motion of the MU 101) is stored. In an alternative exemplary embodiment, the sensors 121-124 may be embodied in a separate external device that connects to the MU 101 through the expansion interface (e.g., sensors incorporated into a SD card, a flash memory card, or similar removable interface). Furthermore, the sensors 121-124 may be of any size. However, according to the preferred embodiments of the present invention, the sensors 121-124 may be small enough so that any added weight and space occupied on the MU 101 is negligible. Because the MU 101 may operate on batteries, the sensors 121-124 may preferably have low power consumption. In addition, the sensors 121-124 may be durable enough to withstand abusive environments.

The sensors 121-124 may be any type of measurement devices capable of monitoring spatial orientation and motion. As described above, the exemplary embodiment of the sensors 121-124 may utilize MEMS technologies for sensing the orientation and motion of the MU 101 in order to allow the user to control a scrolling operation on the display 131. For example, various regions within a three-dimensional reference frame may be defined and associated with (e.g., mapped to) specific applications for the scrolling operation on the display 131. Within each of these defined regions, the spatial orientation of the MU 101 may include any angular orientation with respect to at least one axis in the three-dimensional reference frame for the MU 101, such as, for example, vertical direction (pitch), horizontal direction (roll), lateral direction (yaw), angular slices, or any combination thereof. Furthermore, the observable motion of the MU 101 may include, for example, a velocity value, an acceleration value, an angular acceleration/velocity value, etc.

The methods of detecting and monitoring MU spatial orientation and MU motion, as well as the overall performance of the sensors 121-124, will be described in greater detail below. The methods may involve the use of a mechanism for calibrating the reference 3-axis orientation of the MU 101. Such methods include, but are not limited to: user calibration of the reference point by using some type of input (stylus, finger, audio, gesture); calibration at manufacturing; and/or calibration in a known orientation such as when docked in a docking station. Accordingly, the direction and the speed of the scrolling operation may relate to the relative motion and orientation of the MU 101 to one or more of these reference points. In this way the MU 101 may determine the operation of a scrolling function (e.g., a highlighting function, or any other pointing function) for the user's selection of an item on the display 131. For example, a user tilting the MU 101 along the horizontal axis (e.g., tilting the top of the MU 101 toward the user) may relate to a downward scrolling of the highlighting function. Furthermore, the user tilting the MU 101 along the vertical axis (e.g., titling a horizontal side of the MU 101 toward the user) may relate to a lateral scrolling of the highlighting function.

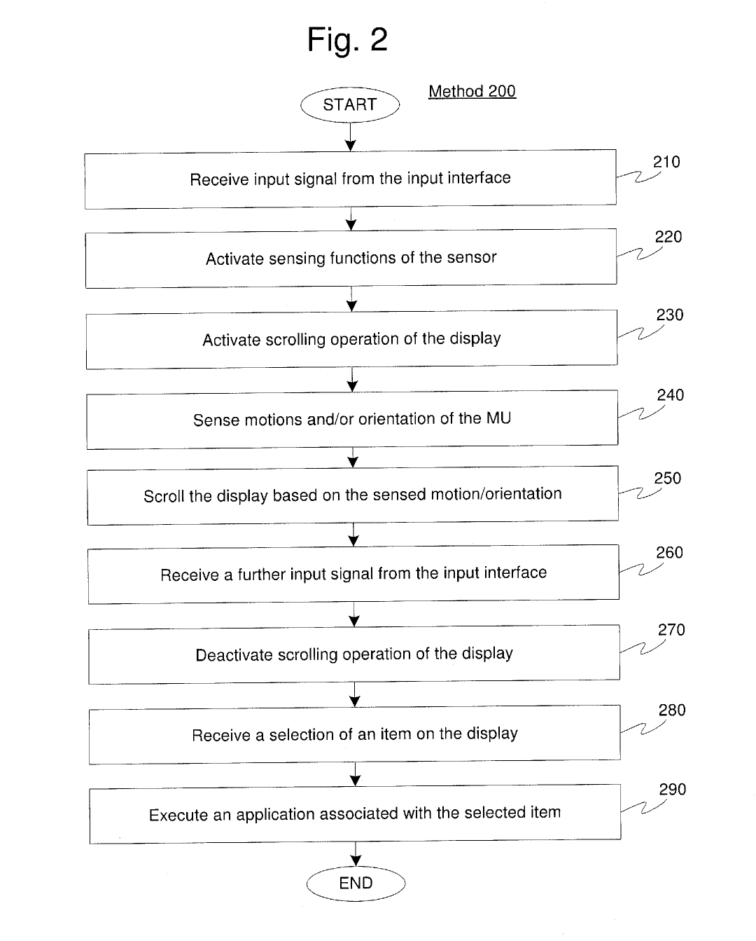

FIG. 2 shows an exemplary method 200 for controlling the functions of a scrolling operation on a display 131 of the MU 101 according to an exemplary embodiment of the present invention. The exemplary method 200 will be described with reference to the exemplary embodiments of FIG. 1. Accordingly, method 200 may allow for a user to control a scrolling operation within the display 131 of the MU 101. The processor 111 may receive motion and orientation data from the sensors 121-124 in order to monitor specific user activity and associate particular activity with a particular orientation and/or motion of the MU 101. Thus, the processor 111 may correlate the control of the scrolling operation of the display 131 with specific movements and positioning of the MU 101.

In step 210, the processor 111 may receive an input signal from the input interface 141. The input signal may be generated via user interaction with the input interface 141. As described above, an exemplary input interface 141 may be a depressible button on the surface of the MU 101. Accordingly, the user may depress this button in order to initiate a scrolling operation of the display 131. This depressible button may be a pressure sensitive button, wherein the speed of the scrolling operation may be controlled by the amount of pressure applied to the button.

Other examples of an input interface 141 may include additional components located on the MU 101, such as a keypad, a trigger, a touch screen, etc. Furthermore, an alternative embodiment of the input interface 141 may generate the input signal remotely from a device such as a ring scanner, a wearable wrist computer, a headset, etc. In addition, the input interface 141 may be a microphone for detecting voice commands from the user. Specifically, the input interface 141 may recognize speech from the user and a particular word or phrase may generate the input signal.

In step 220, the processor 111 may activate a sensing function of the sensors 121-124 within the MU 101. As described above, the sensors 121-124 may be selectively activated by the user when the user wishes to scroll through items on the display 131. This selective activation may limit the use of the sensors 121-124 for instances when need, thereby conserving any resources of the MU 101 required to operate the sensors 121-124.

In step 230, the processor 111 may activate a scrolling operation on the display 131 of the MU 101. In effect, the user interaction with the input interface 141 may control both the activation of the sensing function and the initiation of the scrolling operation. By allowing the user to control when the scrolling operation is active, the user may improve the accuracy and response time for precise selection of an item of the display 131. Specifically, user activation may eliminate any unintentional scrolling of the display 131 while the MU 101 is motion. For example, the user may need to tilt or move the MU 101 in order to read the display 131, or otherwise interact with the MU 101. However, the user may not wish to scroll any of the displayed items while tilting or moving the MU 101. Thus, as described above, the activation of the sensing function and the scrolling operation may be limited to when the input signal is generated on the input interface 141 by the user.

In step 240, the processor 111 may sense any motion and/or orientation of the MU 101 through the use of the sensors 121-124. As described above, the sensors 121-124 may implement MEMS technology to perform the sensing function(s) of the MU 101. Specifically, the sensors 121-124 may detect user activity through observable changes in the directional orientation and the motion and generate MU orientation data and MU motion data, respectively. Based on the monitoring of MU orientation data and MU motion data, the processor 111 may be trained to associate the orientation and motion of the MU 101 with scrolling function of the scrolling operation (e.g., scrolling the highlighting function up/down/laterally, scrolling the highlighting function down a drop-down menu, selection of an icon on a GUI, etc.).

In step 250, the processor 111 may scroll the display 131 based on the sensed motion and/or orientation of the MU 101. According to an exemplary embodiment of the present invention, the processor 111 may compare the MU orientation data and MU motion data to predetermined data, such as default settings. For example, the default settings may be a specific orientation, such as, an angle in which the user is holding the MU 101. A tilting of the top of the MU 101 towards the user from the default orientation may be indicative of a downward scrolling motion. In addition, or in the alterative, the user may roll his wrist to pull the top of the MU 101 towards the user. The angle and/or the motion of the MU 101 detected by the sensors 121-124 may be compared to the default setting in order to determine the direction and/or the speed of the scrolling operation as items on the display 131 are scrolled or highlighted for selection.

In step 260, the processor 111 may receive a further input signal from the user interface 141. Specifically, the user may generate the further input signal in order to terminate the scrolling operation. According to one exemplary embodiment of the present invention, the further input signal may be identical to the input signal received in step 210. For example, if the input interface 141 is a depressible button, then the user may depress the button once to activate the scrolling operation and a second time to deactivate the scrolling operation. Alternatively, the further input signal may be different from the input signal received in step 210. For example, if the input interface 141 is a voice recognition microphone, then the use may activate the scrolling operation with a distinct phrase (e.g., “begin scroll”) and may deactivate the scrolling operation with a different phrase (e.g., “end scroll”). Furthermore, it should be noted that the further input signal may be received from a further input interface, or any combination of various input interfaces. In other words, more than one interface may be used to either activate or deactivate the scrolling operation.

In step 270, the processor 111 may deactivate the scrolling operation on the display 131 of the MU 101. Specifically, the deactivation of the scrolling operation may allow for an item on the display 131 to be highlighted and stop any further movement of the scrolling and/or highlighting function, regardless of any movement or changes in the orientation of the MU 101. Accordingly, this may allow the user to “freeze” the display 131 and allow for a more accurate selection of an item. As described above, the deactivation may prevent an unwanted scrolling of the highlighting function.

In step 280, the processor 111 may receive a selection of an item on the display 131, wherein the item relates to at least one associated application executable by the processor 111. For example, the selectable item may be an icon representing a “shortcut” to a specific file, folder, program or device available to the processor 111. In addition, the selectable item on the display 131 may be a selection on a drop-down list or menu bar, a button on a GUI, a tab for displaying a GUI, a line of text, a text or dialogue box, etc. In step 290, the processor 111 may execute the application associated with the selected item. For example, the processor 111 may open the specified file or folder or may perform the selected program, etc.

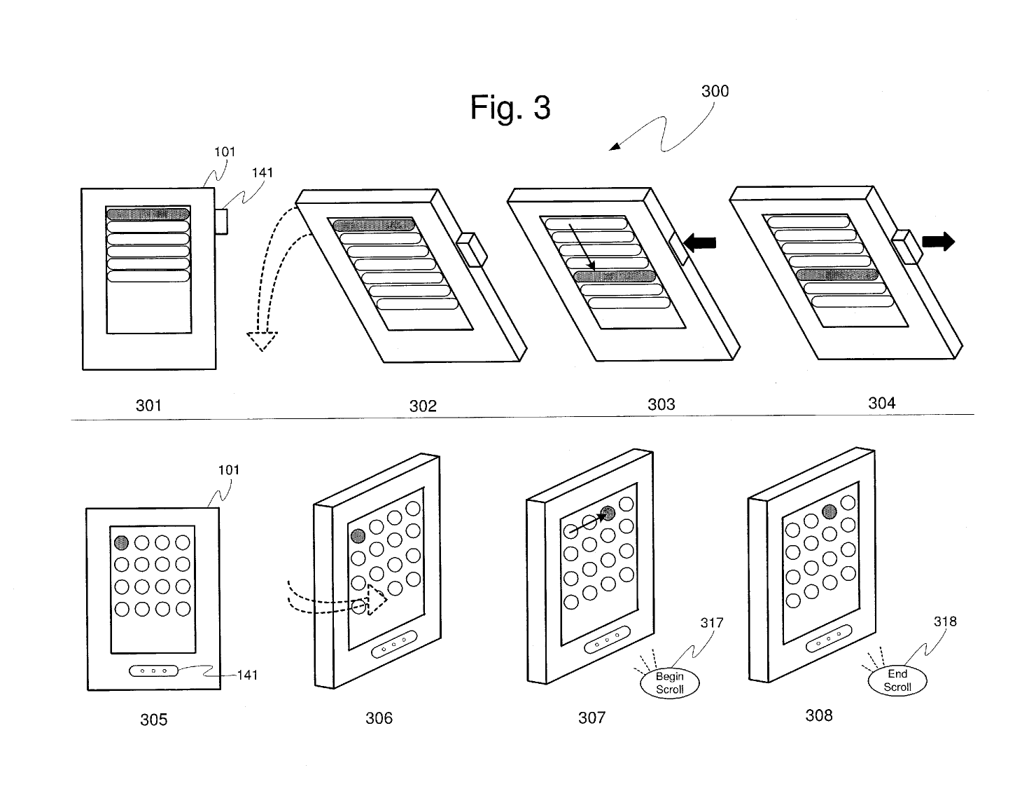

FIG. 3 shows two exemplary motions and orientations in which the MU 101 may be moved in an exemplary three-dimensional space 300 according to the exemplary embodiments of the present invention. The exemplary illustrations 301-308 of FIG. 3 will be described with reference to the exemplary embodiments of FIG. 1. Accordingly, the MU 101 may be manipulated by the user into any of a plurality of various spatial regions within the three-dimensional space 300. It should be noted that the operation and functionalities of the exemplary MU 101 are not limited to the embodiments illustrated in FIG. 3. The illustrations 301-308 merely serve as two examples of any number of operations and functionalities for optimizing the scrolling and selection activity on the display 131 through the use of the sensors 121-124 and the input interface 141.

As described above, the motion and orientation of the MU 101 may be detected by the sensors 121-124, wherein the MU 101 produces orientation and movement data for controlling the scrolling operation on the display 131. Specifically, the direction in which the scrolling operation works depends on the way that the MU 101 is oriented and positioned. The first set of illustrations 301-304 describes a method for scrolling in a downward direction within a drop-down menu of selectable items. While the second set of illustrations 305-308 describe a method for scrolling in a lateral direction within a GUI of selectable items.

Accordingly, the MU 101 depicted in illustrations 301-304 may be equipped with a depressible button such as the input interface 141. Furthermore, the display 13 1 of the MU 101 may include a selection of items on a drop-down menu. In illustration 301, the MU 101 may be held upright and the highlighting function of the display 131 may be held stationary (e.g., highlighting the top item of the menu). In illustration 302, the user may tilt the top portion of the MU 101 towards the user, as indicated by the directional arrow downward. It is important to note that the highlighting function remains stationary as the MU 101 is tilted downward.

In illustration 303, the user may depress the input interface 141 of the MU 101. While the input interface 141 is depressed, the scrolling operation may be activated. As described, above, the input signal from the input interface 141 may activate both the sensors 121-124 and the scrolling operation. Accordingly, the processor 111 of the MU 101 may sense the downward tilting motion of the MU 101 while the input interface 141 is depressed. Therefore, the highlighting function may scroll downward (as depicted by the arrow), thereby allowing the user to browse each of the items displayed within the down-down menu. As described above, the depressible button of the input interface may be pressure sensitive. Therefore, as the user applies more pressure to the button, the highlighting function may scroll at a fast rate while the scrolling operation is activated. Conversely, the user may slow down the rate the highlighting function scrolls by decreasing the amount of pressure applied to the button.

Finally, in illustration 304, the user may release the input interface 141. This release may deactivate the scrolling operation of the display 131. Accordingly, the highlighting function may immediately stop scrolling within the menu regardless of the orientation of the MU 101. Therefore, as opposed to returning the MU 101 to the upright position of illustration 301 in order to hold the highlight on a particular item, the user may manually terminate the scrolling function by releasing the depressible button. Thus, the user has greater control over the scrolling operation and selection of the item.

According to another exemplary embodiment, the MU 101 depicted in illustrations 305-308 may be equipped with a voice recognition microphone as the input interface 141. Furthermore, the display 131 of the MU 101 may include a selection of icons on a GUI. In illustration 305, the MU 101 may be held upright and the highlighting function of the display 131 may be held stationary (e.g., highlighting the left-most icon on the GUI). In illustration 306, the user may rotate the left portion of the MU 101 towards the user, as indicated by the directional arrow inward. It is important to note that the highlighting function remains stationary as the MU 101 is rotated laterally.

In illustration 307, the user may provide a voice command 317 to the input interface 141 of the MU 101 (e.g., “begin scroll”). Once the voice command 317 is received, the scrolling operation and the sensing functions may be activated. Accordingly, the processor 111 of the MU 101 may sense the lateral rotation of the MU 101 while the input interface 141 is activated. Therefore, the highlighting function may scroll laterally (as depicted by the arrow), thereby allowing the user to highlight a selection of icons displayed within the GUI.

Finally, in illustration 308, the user may provide a further voice command 318 to the input interface 141 of the MU 101 (e.g., “end scroll”). This voice command 318 may deactivate the scrolling operation of the display 131. Accordingly, the highlighting function may immediately stop scrolling within the menu regardless of the orientation of the MU 101. Therefore, as opposed to returning the MU 101 to the upright position of illustration 305 in order to hold the highlight on a particular item, the user may manually terminate the scrolling function by providing the voice command 318. Thus, the user has greater control over the scrolling operation and selection of the item. Specifically, the exemplary embodiments of the present invention may simplify methods for selecting items on the display 131 while significantly improving one-handed operation of the MU 101.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
receiving an input signal from an input interface on a mobile unit (“MU”);
activating a scrolling operation of a display of the MU;
sensing at least one of a motion and an orientation of the MU; and
scrolling the display of the MU based on the one of the sensed motion and the sensed orientation of the MU.

2. The method according to claim 1, further comprising:
receiving a further input signal from one of the input interface and a further input interface; and
deactivating the scrolling operation of the display upon receiving the further input signal.

3. The method according to claim 1, further comprising:
receiving a selection of an item within the display, the item corresponding to an application; and
executing the application corresponding to the selection of the item.

4. The method according to claim 1, wherein the sensing at least one of a motion and an orientation of the MU is performed by sensors within the MU.

5. The method according to claim 4, further comprising:
activating a sensing function of the sensors upon receiving the input signal from the input interface.

6. The method according to claim 4, wherein the sensors are one of piezoelectric sensors, optical switches, multi-axis accelerometers, pressure gauges, and micro-electromechanical gyroscopes.

7. The method according to claim 1, wherein the input interface of the MU is one of a depressible button, a keypad, a trigger, a touch screen, a voice recognition microphone, a headset, a ring scanner, a wrist computer, a watch, a wearable component.

8. The method according to claim 1, wherein the input signal is generated from one of a depressed button, a pulled trigger, a voice command, and an activated touch screen.

9. The method according to claim 1, wherein the MU is a mobile telephone, a personal digital assistant (“PDA”), a handheld computing device, a portable barcode scanner, a voice over Internet protocol (“VoIP”) telephone, and a wireless communication device.

10. The method according to claim 1, wherein a rate that the display scrolls is based on a degree of pressure applied to the input interface.

11. A mobile computing device comprising:
a display;
an input interface for receiving an input signal;
at least one sensor for sensing at least one of an orientation and a motion of the mobile computing device; and
a processor receiving the input signal from the input interface, activating a scrolling operation of the display and scrolling the display of the device based on the one of the sensed motion and the sensed orientation of the device.

12. The mobile computing device according to claim 11, wherein the processor receives a further input signal from one of the input interface and a further input interface, and deactivates the scrolling operation of the display upon receiving the further input signal.

13. The mobile computing device according to claim 11, wherein the processor receives a selection of an item within the display, the item corresponding to an application, and the processor executes the application corresponding to the selection of the item.

14. The mobile computing device according to claim 11, wherein the processor activates a sensing function of the sensors upon receiving the input signal from the input interface.

15. The mobile computing device according to claim 11, wherein the sensors are one of piezoelectric sensors, optical switches, multi-axis accelerometers, pressure gauges, and micro-electromechanical gyroscopes.

16. The mobile computing device according to claim 11, wherein the input interface is one of a depressible button, a keypad, a trigger, a touch screen, a voice recognition microphone, a headset, a ring scanner, a wrist computer, a watch, a wearable component.

17. The mobile computing device according to claim 11, wherein the input signal is generated from one of a depressed button, a pulled trigger, a voice command, and an activated touch screen.

18. The mobile computing device according to claim 11, wherein the mobile computing device is one of a mobile telephone, a personal digital assistant (“PDA”), a handheld computing device, a portable barcode scanner, a voice over Internet protocol (“VoIP”) telephone, and a wireless communication device.

19. The mobile computing device according to claim 11, wherein a rate that the display scrolls is based on a degree of pressure applied to the input interface

20. A system, comprising:
a receiving means receiving an input signal from an input interface on a mobile unit (“MU”);
an activating means activating a scrolling operation of a display of the MU;
a sensing means sensing at least one of a motion and an orientation of the MU; and
a scrolling means scrolling the display of the MU based on the one of the sensed motion and the sensed orientation of the MU.
